(19) United States
(12) Patent Application Publication
(10) Pub. No.: US 2020/0180427 A1
(43) Pub. Date: Jun. 11, 2020

(54) METHOD OF MANUFACTURING A PLASTIC TANK

(71) Applicant: MAGNA STEYR Fuel Systems GesmbH, Sinabelkirchen (AT)

(72) Inventors: Philipp FUCHS, Graz (AT); Rainer PUCHLEITNER, Graz (AT); Christian URDL, Hitzendorf (AT); Florian WIMMER, Riegersburg (AT)

(21) Appl. No.: 16/654,211

(22) Filed: Oct. 16, 2019

(30) Foreign Application Priority Data
Dec. 10, 2018 (EP) 18211294.6

(51) Int. Cl. B60K 15/03; B29C 70/44

(52) U.S. Cl. CPC B60K 15/03; B60K 2015/03493; B60K 2015/03032; B29C 70/44

(57) ABSTRACT

A process for manufacturing a plastic tank for a motor vehicle. The process includes inserting at least one stiffening profile into a shell mould having walls. The at least one stiffening profile is configured to minimise undesirable deformation of the plastic tank. The process also includes applying a negative pressure to simultaneously maintain a position of each stiffening profile in the shell mould, form a tank wall by facilitating flow of plastic material onto the walls of the shell mould, and form a form-fitting connection between the tank wall and each stiffening profile by facilitating flow of the plastic material around the stiffening profile.

### CROSS-REFERENCE TO RELATED APPLICATIONS

The present application claims priority 35 U.S.C. § 119 to European Patent Publication No. EP 18211294.6 (filed on Dec. 10, 2018), which is hereby incorporated by reference in its complete entirety.

### TECHNICAL FIELD

Embodiments relate to a process for manufacturing a plastic tank, and particularly, a process for manufacturing a plastic tank for a motor vehicle.

### BACKGROUND

It is known that, in addition to a number of positive properties, plastic tanks, which have recently been used for instance as fuel tanks in motor vehicles such as passenger cars and trucks, are problematic in terms of possible deformations of the fuel tank. During normal operation of tank systems in motor vehicles, high levels of deformation may occur in certain areas of the tank system. In particular, saddle tank systems, which may have indentations and whose geometry is heavily dependent on vehicle parts such as cardan shafts and exhaust systems, must have high rigidity in the tunnel area. Consecutively occurring pressure and temperature peaks in zones of the tank can cause great relative movements of the tank shells, especially in the case of plastic tanks, and must be limited by design measures.

Support concepts to reduce undesirable deformations of the fuel tanks, which are known from the state of the art, usually use body-fixed attachment points to limit deformations of the tank walls. However, for pressurised tank systems in particular, these measures are not sufficient and additional measures must be used to reduce deformations. The shell thickness of the tank bladder is often increased or stiffening welded-on components are used to limit the deformation. Such measures result in significant losses of tank volume and thus limit the function of the system.

### SUMMARY

Embodiments relate to a process for manufacturing an enhanced plastic tank having reduced undesirable deformations without significantly reducing the overall volume of the fuel tank. The plastic tank manufactured can be a plastic tank for a truck, and particularly, a semi-trailer tank.

In accordance with embodiments, a process for manufacturing a plastic tank, the method comprising inserting at least one stiffening profile into a shell mould; maintaining the position of the stiffening profile in the shell mould via negative pressure while simultaneously forming a tank wall such that material is sucked onto walls of the shell mould via the negative pressure and also the material is sucked onto the stiffening profile to form a form-fitting connection between the tank wall and the stiffening profile. The stiffening profile is configured to minimise undesirable deformation of the plastic tank.

In accordance with embodiments, a plastic tank is formed in a shell mould via a vacuum which sucks the sheet material against the mould wall, and particularly, by deep drawing via vacuum. The vacuum for forming the tank wall of the plastic tank is used simultaneously to hold at least one stiffening profile in the shell mould in position during the manufacturing process of the tank wall.

In accordance with embodiments, the plastic material of the tank wall is sucked by the same vacuum against the shells of the shell mould, and thus, also against the stiffening profile. In that way, the material of the tank wall is to form behind areas of the stiffening profile, and particularly, behind undercuts and the like. As a result, a form-fitting connection of the stiffening profile on the tank wall of the plastic tank is formed. Such a connection is to prevent the stiffening profile from adhering to the tank wall with a material-locking hold.

In accordance with embodiments, the stiffening profile can achieve a high stiffening effect with minimal volume loss. The manufacture of the plastic tank and its stiffening is very simple, inexpensive and fast.

In accordance with embodiments, at least two or more stiffening profiles are attached to the tank wall of the plastic tank in the manner described herein.

In accordance with embodiments, the stiffening profile or profiles may form struts or ribs on the tank wall.

In accordance with embodiments, the stiffening profile is formed having T-shaped or cross-section to generate a high geometric moment of resistance.

In accordance with embodiments, the stiffening profile is held in position in the shell mould so that a wider end of the stiffening profile, and particularly, the horizontal bar of a T-shape, projects further from the shell mould than a narrower end of the stiffening profile, and also the vertical bar of a T-shape.

In accordance with embodiments, the stiffening profile is preferably made of fibre-reinforced plastic. The stiffening profile can also be made of metal.

In accordance with embodiments, the stiffening profile is inserted into a suitable recess in the shell mould and held in position in the recess via negative pressure.

In accordance with embodiments, the stiffening profile can be produced by a continuous process such as extrusion or by a discontinuous process such as injection moulding before insertion into the shell mould.

In accordance with embodiments, the stiffening profile is preferably bent into a shape adapted to the later tank wall before being inserted into the shell mould.

In accordance with embodiments, the stiffening profile has a plurality of openings, so that, when the tank wall is formed, the material of the tank wall is sucked through the openings and a form-fitting connection is created between the tank wall and the stiffening profile. This further increases the strength of the connection to the plastic container.

In accordance with embodiments, the method also includes conducting a cooling process after forming the tank wall. Such a cooling process is to cause shrinking of the material of the tank wall in such a manner that the forming-fitting connection between the tank wall and the stiffening profile is enhanced and a pre-stress is created in the reinforcing element.

In accordance with embodiments, the stiffening profile preferably has a recess for length compensation to be formed at least at one end or at both ends. As a result, shrinkage of the material of the tank wall is to be absorbed by the recess during the cooling process.

In accordance with embodiments, the end areas of the stiffening profile are preferably tapered to ensure a homogeneous stress curve.

### DRAWINGS

Embodiments will be illustrated by way of example in the drawings and explained in the description below.

FIG. 1 illustrates a schematic view, from the outside, of a section of a plastic tank manufactured by a process in accordance with embodiments.

FIG. 2 illustrates a view of a stiffening profile from the side facing the tank wall.

FIG. 3 illustrates a view of the stiffening profile of FIG. 2 from the side facing away from the tank wall.

FIG. 4 illustrates a view of the plastic tank of FIG. 1 from the side and shows the position of section A-A.

FIG. 5 illustrates a sectional view of section A-A of FIG. 4.

### DESCRIPTION

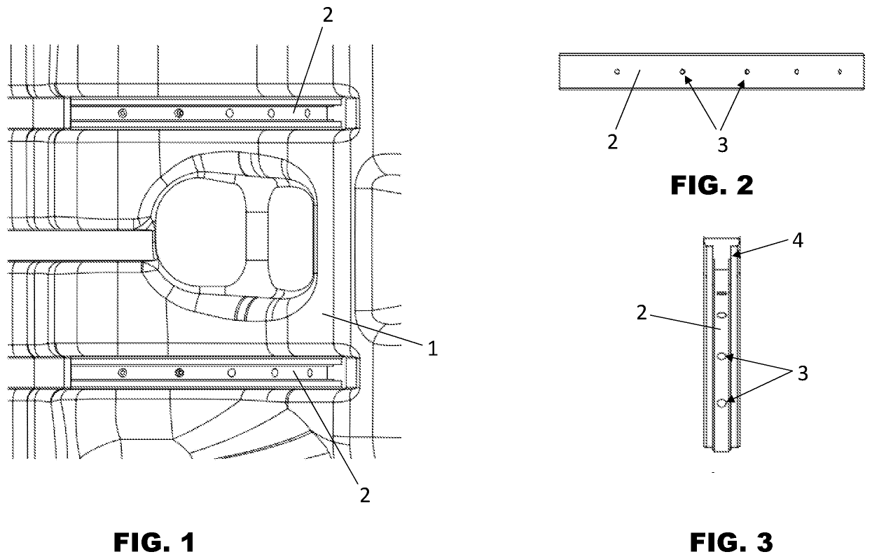

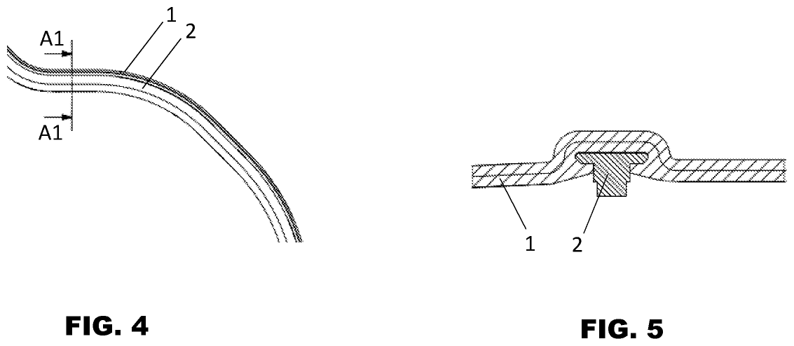

FIG. 1 illustrates a section of a plastic tank which has been manufactured in accordance with embodiments. The plastic tank comprises a tank wall 1 and at least one stiffening profile 2 to minimise undesirable deformation of the plastic tank. The plastic tank may be composed of a plastic material. Such a plastic material may comprise, for example, high-density polyethylene (HDPE). In the illustrated embodiment, a pair of stiffening profiles 2, but embodiments are not limited to the same, and may encompass any number of stiffening profiles that permit practice of embodiments.

During formation of the plastic tank in accordance with embodiments, each stiffening profile 2 is to be inserted into a shell mould. The stiffening profile 2 is held in position in the shell mould via negative pressure. The material of the tank wall 1 is sucked onto the walls of the shell mould via negative pressure to form the tank wall 1. When forming the tank wall 1, the material of the tank wall 1 is also sucked around the stiffening profile 2 to thereby form a forming-fitting connection between the tank wall 1 and the stiffening profile 2.

The stiffening profile 2 has a T-shaped cross-section, and thus, has undercuts which can be engaged from behind by the material of the tank wall 1. In accordance with embodiments, there is no material-locking hold between the stiffening profile 2 and the tank wall 1.

The assembly is therefore carried out by enclosing the tank shell material in a form-fitting manner in the joining process. The stiffening profiles 2 are inserted into the open shell mould in a cavity provided for this purpose, and held in position by applying a vacuum. In a further process block, material from the tank wall 1 is sucked around the profile of the stiffening profiles 2 by applying negative pressure. In this way, the connection between rib elements, i.e., the stiffening profiles 2, and tank bladder, i.e., the tank wall 1, is already achieved during the forming process. The assembly is carried out in a form-fitting manner, as illustrated, for example, in FIGS. 1, 3, and 5 on the shape of the stiffening profile 2. It is also possible to penetrate the inserted stiffening profile 2 through the molten shell material, i.e., material of the tank wall 1. For this purpose, openings 3 can be formed in the stiffening profile 2, as illustrated in FIGS. 1 to 3. This creates additional strength through additional undercuts.

Additional pressing of the tank wall 1 to the rib or the stiffening profile 2 can be achieved via in a cooling process to shrink the shell material by a predetermined amount, such as, for example, roughly 3%. Shrinkage in the longitudinal direction of the rib 2 can be provided via a suitable longitudinal groove or recess 4 for length compensation in the outlet area of the ribs 2.

The stiffening profiles is composed of a material having high strength and high bending stiffness. Fibre-reinforced plastics and metal components are particularly suitable for this purpose.

The production of the stiffening profiles 2 can be carried out either by a discontinuous process such as injection moulding or a continuous process such as extrusion of a profile.

In accordance with embodiments, each stiffening profile 2 can be bent into shape by a forming process. The geometric design of each stiffening profile 2 can be designed in such a way that a positive and non-positive but not material-locking bond can be formed between the tank wall 1 and the stiffening element 2. The geometry of the stiffening element 2 is adapted to the tank geometry. Preferred geometries are struts on the tank shell.

In accordance with embodiments, each stiffening profile 2 may have a plurality of openings 3 to facilitate, during formation of the tank wall 1, flow of the material of the tank wall 1 through the openings 3 during the application of negative pressure. As a result, an enhanced forming-fitting connection is created between the tank wall 1 and the stiffening profile 2.

The terms “coupled,” “attached,” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

### LIST OF REFERENCE SYMBOLS

1 Tank wall
2 Stiffening profile
3 Opening
4 Recess

What is claimed is:

1. A process for manufacturing a plastic tank for a motor vehicle, the process comprising:
inserting at least one stiffening profile into a shell mould having walls, the at least one stiffening profile configured to minimise undesirable deformation of the plastic tank; and
applying a negative pressure to simultaneously: maintain a position of each stiffening profile in the shell mould, form a tank wall by facilitating flow of plastic material onto the walls of the shell mould, and form a form-fitting connection between the tank wall and each stiffening profile by facilitating flow of the plastic material around the stiffening profile.

2. The process of claim 1, wherein the stiffening profile is composed of a fibre-reinforced plastic.

3. The process of claim 1, wherein inserting the at least one stiffening profile comprises inserting the at least one stiffening profile into a corresponding recess of the shell mould.

4. The process of claim 3, wherein applying negative pressure comprises maintaining the position of each stiffening profile in the corresponding recess of the shell mould.

5. The process of claim 1, further comprising, before inserting the at least one stiffening profile, producing the at least one stiffening profile by extrusion.

6. The process of claim 1, further comprising, before inserting the at least one stiffening profile, producing the at least one stiffening profile by injection moulding.

7. The process of claim 1, further comprising, before inserting the at least one stiffening profile, producing the at least one stiffening profile to have a plurality of openings such that, during formation of the tank wall, the plastic material flows through the openings to form the forming-fitting connection.

8. The process of claim 1, further comprising, before inserting the at least one stiffening profile, producing the at least one stiffening profile to have a longitudinal recess at least at one end.

9. The process of claim 1, further comprising, before inserting the at least one stiffening profile, bending the at least one stiffening profile into a shape adapted to the tank wall.

10. The process of claim 1, further comprising, after applying the negative pressure, strengthening the forming-fitting connection by reducing the size of the tank wall via conduction of a cooling process.

11. A process for manufacturing a tank for a motor vehicle, the process comprising:
inserting at least one stiffening profile, composed of a fibre-reinforced plastic, into a corresponding recess of a plastic shell mould having walls, the at least one stiffening profile configured to minimise undesirable deformation of the tank; and
applying a negative pressure to simultaneously: maintain a position of each stiffening profile in the corresponding recess of the shell mould, form a tank wall by facilitating flow of plastic material onto the walls of the shell mould, and form a form-fitting connection between the tank wall and each stiffening profile by facilitating flow of the plastic material around the stiffening profile.

12. The process of claim 11, further comprising, before inserting the at least one stiffening profile, producing the at least one stiffening profile by extrusion.

13. The process of claim 11, further comprising, before inserting the at least one stiffening profile, producing the at least one stiffening profile by injection moulding.

14. The process of claim 11, further comprising, before inserting the at least one stiffening profile, producing the at least one stiffening profile to have a plurality of openings such that, during formation of the tank wall, the plastic material flows through the openings to form the forming-fitting connection.

15. The process of claim 11, further comprising, before inserting the at least one stiffening profile, producing the at least one stiffening profile to have a longitudinal recess at least at one end.

16. The process of claim 11, further comprising, before inserting the at least one stiffening profile, bending the at least one stiffening profile into a shape adapted to the tank wall.

17. The process of claim 11, further comprising, after applying the negative pressure, strengthening the forming-fitting connection by reducing the size of the tank wall via conduction of a cooling process.

18. A process for manufacturing a tank for a motor vehicle, the process comprising:
inserting at least one stiffening profile into a shell mould having walls; and
applying a negative pressure to simultaneously: maintain a position of each stiffening profile in the shell mould, form a tank wall by facilitating flow of material onto the walls of the shell mould, and form a form-fitting connection between the tank wall and each stiffening profile by facilitating flow of the material around the stiffening profile.

19. The process of claim 18, further comprising, before inserting the at least one stiffening profile, producing the at least one stiffening profile to have a plurality of openings such that, during formation of the tank wall, the plastic material flows through the openings to form the forming-fitting connection.

20. The process of claim 18, further comprising, before inserting the at least one stiffening profile, producing the at least one stiffening profile to have a longitudinal recess at least at one end.
